(19) United States
(12) Patent Application Publication
(10) Pub. No.: US 2018/0292701 A1
(43) Pub. Date: Oct. 11, 2018

(54) LIQUID CRYSTAL DISPLAY

(71) Applicants: HKC Corporation Limited, Shenzhen City, Guangdong (CN); Chongqing HKC Optoelectronics Technology Co., Ltd., Chongqing (CN)

(72) Inventor: Chung-Kuang CHIEN, Chongqing (CN)

(73) Assignees: HKC Corporation Limited, Shenzhen City, Guangdong (CN); Chongqing HKC Optoelectronics Technology Co., Ltd., Chongqing (CN)

(21) Appl. No.: 15/555,412

(22) PCT Filed: Apr. 14, 2017
(86) PCT No.: PCT/CN2017/080555

§ 371 Date: Sep. 1, 2017

(30) Foreign Application Priority Data
Apr. 5, 2017 (CN) 201710218564.6

(51) Int. Cl. G02F 1/1333; G02F 1/1339; G02F 1/1335

(52) U.S. Cl. CPC G02F 1/133308; G02F 1/1339; G02F 2001/133507; G02F 1/133504; G02F 2001/133317; G02F 1/133602

(57) ABSTRACT

This application relates to a liquid crystal display. The liquid crystal display includes: a middle frame, a backlight unit including a backlight module and a bezel carrying the backlight module, where the backlight module includes at least a diffuse sheet, a prism sheet, and a dual brightness enhancement film sequentially superimposed on the bezel; and a liquid crystal display panel assembled to the bezel by means of a spacer plate, where a dark or opaque adhesive is formed between the middle frame and the bezel by using a dispensing process of a dispenser, so that the middle frame and the bezel are bonded to each other. The spacer plate and the middle frame are integrally formed, and the spacer plate is formed by extending from the middle frame toward a direction between the bezel and the liquid crystal display panel.

### BACKGROUND

### Technical Field

The present application relates to a liquid crystal display, and in particular, to a light leakage-preventing liquid crystal display.

### Related Art

With development of flat-panel display technologies, because of having advantageous characteristics, such as a light weight and slimness, low power consumption, and no radiation, liquid crystal displays (LCDs) gradually replace conventional anode ray tube displays. A common liquid crystal display usually includes a liquid crystal display panel (Open Cell), a backlight unit, a middle frame, and a front frame. In recent years, a process of the liquid crystal display panel develops toward a narrow-bezel or bezel-less trend. Requirements for overall assembly are increasingly stricter, and in particular, in a narrow-bezel design combined with a curved surface panel or a bezel-less design combined with a curved surface panel, after the middle frame and the backlight unit are assembled with the liquid crystal display panel, a light leakage phenomenon is likely to occur.

There are several problems in approaches in the prior art: when a screw is used to lock the middle frame and an aluminum bezel, the screw needs to penetrate through foam and a black conductive tape. As a result, scraps may drop from the black conductive tape or the foam, or remain on a thread of the screw, severely affecting an assembly yield of the liquid crystal display. In assembly of the middle frame and the aluminum bezel, extra manpower is needed to paste black conductive tapes and foam all around the aluminum bezel, and a locking step of tens of screws is further needed, resulting in high process complexity and waste of a lot of manpower resources. Although the black conductive tape exists between the middle frame and the aluminum bezel as a light leakage structure, the black conductive tape may crack at a high temperature, and an extra circle of foam needs to be added. A gap between the middle frame and the aluminum bezel is excessive large. As a result, the light leakage phenomenon of the liquid crystal display is severer.

### SUMMARY

To solve the foregoing technical problem, this application is directed to providing a liquid crystal display, and in particular, a light leakage-preventing liquid crystal display.

The following technical solutions are used to achieve the objective of this application and resolve the technical problem of this application.

This application provides a liquid crystal display, comprising:

a middle frame;
a backlight unit, comprising a backlight module and a bezel carrying the backlight module; and
a liquid crystal display panel, assembled to the bezel by means of a spacer plate, where
a dark or opaque adhesive is formed between the middle frame and the bezel to bond the middle frame and the bezel to each other.

In an embodiment of this application, the adhesive formed between the middle frame and the bezel is a black silica gel.

In an embodiment of this application, a thickness of the black silica gel is 0.3 mm.

In an embodiment of this application, the black silica gel is formed between the middle frame and the bezel by using a dispensing process of a dispenser.

In an embodiment of this application, an optical density value of the black silica gel is in a range of 2/0.8 μm to 2/0.2 μm.

In an embodiment of this application, an optical density value of the black silica gel is preferably 2/0.5 mm.

In an embodiment of this application, the backlight module comprises a diffuse sheet, a prism sheet, and a dual brightness enhancement film sequentially superimposed on the bezel.

In an embodiment of this application, a joining tape is further comprised to bond the liquid crystal display panel and the spacer plate.

In an embodiment of this application, the spacer plate and the middle frame are integrally formed, and the spacer plate is formed by extending from the middle frame toward a direction between the bezel and the liquid crystal display panel.

To resolve problems in the prior art, this application is implemented by using another technical solution.

In another embodiment of this application, a liquid crystal display is provided, comprising:

a middle frame;
a backlight unit, comprising a backlight module and an aluminum bezel carrying the backlight module, where the backlight module comprises at least a diffuse sheet, a prism sheet, and a dual brightness enhancement film sequentially superimposed on the aluminum bezel; and
a liquid crystal display panel, assembled to the aluminum bezel by means of a spacer plate, where
a dark or opaque adhesive is formed between the middle frame and the aluminum bezel by using a dispensing process of a dispenser, so that the middle frame and the aluminum bezel are bonded to each other; and the spacer plate and the middle frame are integrally formed, and the spacer plate is formed by extending from the middle frame toward a direction between the bezel and the liquid crystal display panel.

In another embodiment of this application, the dark adhesive formed between the middle frame and the aluminum bezel is a black silica gel.

In another embodiment of this application, a thickness of the black silica gel is 0.3 mm.

In another embodiment of this application, the black silica gel is formed between the middle frame and the aluminum bezel by using a dispensing process of a dispenser.

In another embodiment of this application, an optical density value of the black silica gel is in a range of 2/0.8 μm to 2/0.2 μm.

In another embodiment of this application, an optical density value of the black silica gel is preferably 2/0.5 mm.

In another embodiment of this application, a joining tape is further comprised to bond the liquid crystal display panel and the spacer plate.

In another embodiment of this application, the joining tape is an adhesive such as a double-sided tape, a foam tape, or a light shielding tape.

In this application, replacing exemplary pasting of a conductive adhesive and foam with a black silica gel mainly has the following advantages. Upon a reliability analysis (RA) test, strength of the black silica gel after being cured may be 2 MPa or higher. Therefore, only 8 to 12 screws need to be used to lock the middle frame and the bezel, thereby effectively alleviating a problem that a great amount of manpower is needed for assembly in the prior art. Because the black silica gel has adhesivity and extensibility, a pollution problem of dropped buffings caused by pasting the conductive adhesive and foam in the conventional art may be alleviated, and a step of pasting the conductive adhesive and the foam is omitted, thereby improving production efficiency of the liquid crystal display. The black silica gel is of a black adhesive material and can decrease a gap between the middle frame and the bezel and effectively prevent a problem of light leakage on a side of the liquid crystal display.

### BRIEF DESCRIPTION OF THE DRAWINGS

FIG. 1 is a schematic diagram of a local structure of an exemplary liquid crystal display;

FIG. 2 is a schematic diagram of a local structure of a liquid crystal display according to an embodiment of this application; and

FIG. 3 is a schematic diagram of a local structure of a liquid crystal display according to another embodiment of this application.

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface”, merely refer to directions of the accompanying drawings. Therefore, the used terms about directions are used to describe and understand this application, and are not intended to limit this application.

The accompanying drawings and the description are considered to be essentially exemplary, rather than limitative. In figures, units with similar structures are represented by using a same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a substrate is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located on or below a target component, but does not mean that the component needs to be located on top of a gravity direction.

To further describe technical measures taken in this application for achieving a predetermined invention objective and effects of this application, with reference to the accompany drawings and preferred embodiments, the following describes in detail specific implementations, structures, features, and effects of a liquid crystal display provided in this application.

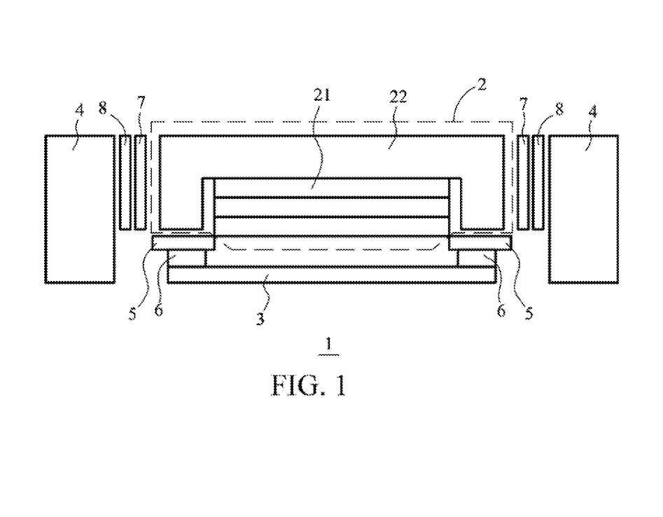

Referring to FIG. 1, FIG. 1 is a schematic diagram of a local structure of an exemplary liquid crystal display. As shown in FIG. 1, a liquid crystal display 1 includes a backlight unit 2, a liquid crystal display panel 3, and a middle frame 4. The backlight unit 2 includes a backlight module 21 and an aluminum bezel 22. The backlight module 21 includes a diffuse sheet, a prism sheet, and a dual brightness enhancement film. An exemplary method for assembling the liquid crystal display 1 includes first combining the aluminum bezel 22 of the backlight unit 2 and a spacer plate 5; then joining the spacer plate 5 to the liquid crystal display panel 3 by means of an adhesive 6, where the adhesive 6 may be an adhesive such as a double-sided tape, a foam tape, or a light shielding tape; then pasting black conductive tapes 7 all around the aluminum bezel 22 to achieve an effect of preventing light leakage; subsequently, adding a circle of foam 8 between the middle frame 4 and the black conductive tape 7, where because when the liquid crystal display 1 is at a high temperature, the black conductive tape 7 between the aluminum bezel 22 and the middle frame 4 is likely to crack, and an effect of the foam 8 is to prevent the black conductive tape 7 from cracking and combine the middle frame 4 and the aluminum bezel 22 more tightly; and finally, using tens of screws to lock the middle frame 4, the foam 8, the black conductive tape 7, and the aluminum bezel 22.

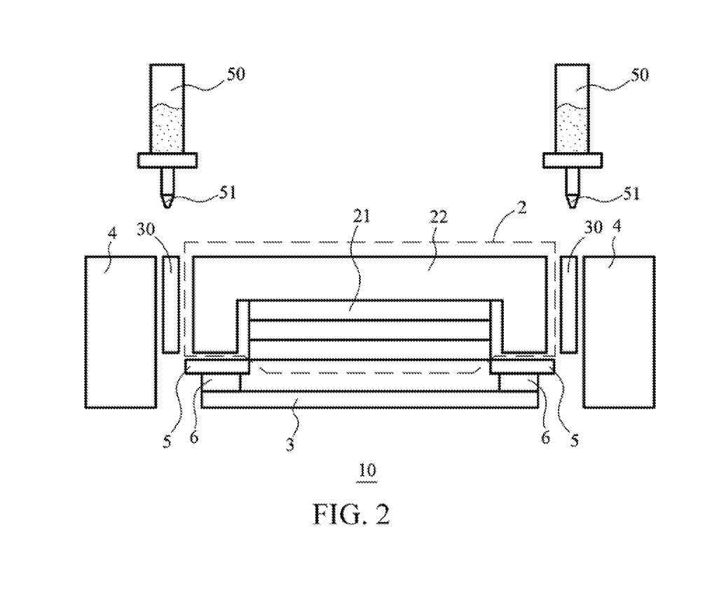

Referring to FIG. 2, FIG. 2 is a schematic diagram of a local structure of a liquid crystal display 10 according to an embodiment of this application. As shown in FIG. 2, the liquid crystal display 10 includes at least a backlight unit 2, a liquid crystal display panel 3, and a middle frame 4. The backlight unit 2 includes a backlight module 21 and a bezel 22 carrying the backlight module 21. In an embodiment, the bezel 22 may be, for example, an aluminum bezel, and the backlight module 21 includes a diffuse sheet, a prism sheet, and a dual brightness enhancement film sequentially superimposed on the bezel 22. The liquid crystal display panel 3 is assembled to the bezel 22 by means of a spacer plate 5.

In an embodiment of this application, a method for assembling the liquid crystal display 10 includes: first combining the bezel 22 of the backlight unit 2 and a spacer plate 5; then joining the spacer plate 5 and the liquid crystal display panel 3 by means of a joining tape 6, where the joining tape 6 may be an adhesive such as a double-sided tape, a foam tape, or a light shielding tape; subsequently, by means of a dispensing process of a dispenser, accommodating a dark or opaque adhesive in a dispensing head 50, where the dark adhesive may be a black silica gel 30; and controlling parameters such as a time, a temperature, and an output amount, and outputting a proper amount of the black silica gel 30 from an output hole 51 to dispose it between the middle frame 4 and the bezel 22, so that the middle frame 4 and the bezel 22 are bonded to each other.

The black silica gel 30 is a high-temperature adhesive in the dispensing head 50. After a proper amount of the black silica gel 30 is output from the output hole 51, a thin layer of adhesive with a thickness of 0.2 mm to 0.5 mm is formed between the middle frame 4 and the bezel 22, and a preferable thickness is 0.3 mm. After the adhesive is cooled, the middle frame 4 and the bezel 22 are bonded to each other, thereby reducing a distance between the middle frame 4 and the bezel 22 and effectively resolving a problem of light leakage on a side of the liquid crystal display 10. In addition, an optical density (OD) value of the black silica gel 30 is in a range of 2/0.8 μm to 2/0.2 μm, and a preferable optical density value is 2/0.5 μm, thereby effectively resolving a problem of light leakage on a side of the liquid crystal display 10.

Finally, several screws are used to penetrate through the middle frame 4, the black silica gel 30, and the bezel 22 to lock the middle frame 4 and the bezel 22, so that assembly of the liquid crystal display 10 of this application is completed.

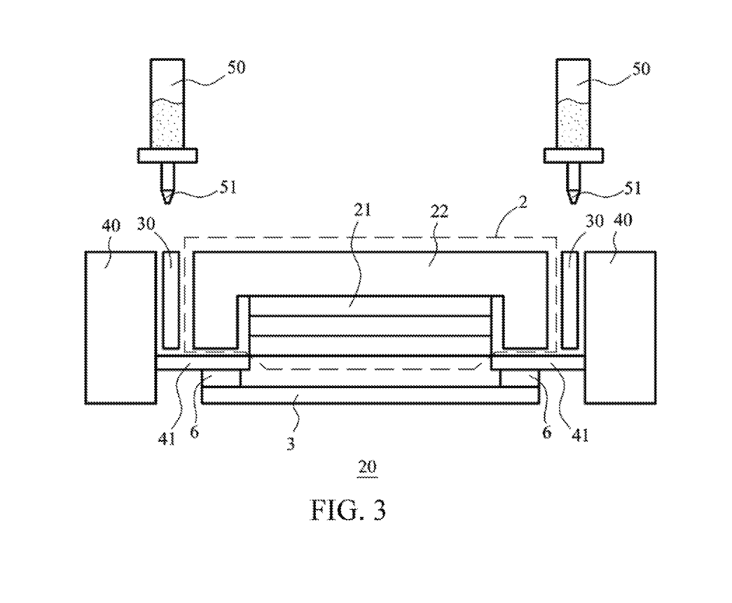

Referring to FIG. 3, FIG. 3 is a schematic diagram of a local structure of a liquid crystal display 20 according to another embodiment of this application. As shown in FIG. 3, the liquid crystal display 20 includes at least a backlight unit 2, a liquid crystal display panel 3, and a middle frame 40. The backlight unit 2 includes a backlight module 21 and a bezel 22 carrying the backlight module 21. In an embodiment, the bezel 22 may be, for example, an aluminum bezel, and the backlight module 21 includes a diffuse sheet, a prism sheet, and a dual brightness enhancement film sequentially superimposed on the bezel 22. The liquid crystal display panel 3 is assembled to the bezel 22 by means of a spacer plate 41. It should be noted that the spacer plate 41 and the middle frame 40 in this embodiment are integrally formed, and the spacer plate 41 is formed by extending from the middle frame 40 toward a direction between the bezel 22 and the liquid crystal display panel 3.

In an embodiment of this application, a method for assembling the liquid crystal display 20 includes: first combining the bezel 22 of the backlight unit 2 and the spacer plate 41; then joining the spacer plate 41 and the liquid crystal display panel 3 by means of a joining tape 6, where the joining tape 6 may be an adhesive such as a double-sided tape, a foam tape, or a light shielding tape; then, by means of a dispensing process of a dispenser, accommodating a dark adhesive in a dispensing head 50, where the dark adhesive may be a black silica gel 30; controlling parameters such as a time, a temperature, and an output amount, and outputting a proper amount of the black silica gel 30 from an output hole 51 to dispose it between the middle frame 40 and the bezel 22, so that the middle frame 40 and the bezel 22 are bonded to each other.

The black silica gel 30 is a high-temperature adhesive in the dispensing head 50. After a proper amount of the black silica gel 30 is output from the output hole 51, a thin layer of adhesive with a thickness of 0.2 mm to 0.5 mm is formed between the middle frame 40 and the bezel 22, and a preferable thickness is 0.3 mm. After the adhesive is cooled, the middle frame 40 and the bezel 22 may be bonded to each other, thereby reducing a distance between the middle frame 40 and the bezel 22. The spacer plate 41 and the middle frame 40 are integrally formed, thereby effectively resolving a problem of light leakage on a side of the liquid crystal display 20. In addition, an optical density (OD) value of the black silica gel 30 is in a range of 2/0.8 μm to 2/0.2 μm, and a preferable optical density value is 2/0.5 μm, thereby effectively resolving a problem of light leakage on a side of the liquid crystal display 20.

Finally, several screws are used to penetrate through the middle frame 40, the black silica gel 30, and the bezel 22 to lock the middle frame 40 and the bezel 22, so that assembly of the liquid crystal display 20 of this embodiment is completed.

In the foregoing embodiments, the black silica gel 30 is used to replace the conductive tape and the foam in the prior art. The black silica gel 30 may be applied to a process of manufacturing a narrow-bezel liquid crystal display panel, and may also be applied to a process of manufacturing a flexible thin film transistor (Flexible TFT) liquid crystal display.

In this application, replacing exemplary pasting of a conductive adhesive and foam with a black silica gel mainly has the following advantages. Upon a reliability analysis (RA) test, strength of the black silica gel 30 after being cured may be 2 MPa or higher. Therefore, only 8 to 12 screws need to be used to lock the middle frame 4 or 40 and the bezel 22, thereby effectively alleviating a problem that a great amount of manpower is needed for assembly in the prior art. Because the black silica gel 30 has adhesivity and extensibility, a pollution problem of dropped buffings caused by pasting the conductive adhesive and foam in the conventional art may be alleviated, and a step of pasting the conductive adhesive and the foam is omitted, thereby improving production efficiency of the liquid crystal display 10 or 20. The black silica gel 30 is of a black adhesive material and can decrease a gap between the middle frame 4 or 44 and the bezel 22 and effectively prevent a problem of light leakage on a side of the liquid crystal display.

Terms such as “in some embodiments” and “in various embodiments” are repeatedly used. Usually, the terms do not refer to a same embodiment; but they may also refer to a same embodiment. Words such as “comprise”, “have”, “include” are synonyms, unless other meanings are indicated in the context.

The foregoing descriptions are merely preferred embodiments of this application, and are not intended to limit this application in any form. Although this application has been disclosed above through the preferred embodiments, the embodiments are not intended to limit this application. Any person skilled in the art can make some equivalent variations or modifications according to the foregoing disclosed technical content without departing from the scope of the technical solutions of this application to obtain equivalent embodiments. Any simple amendment, equivalent change or modification made to the foregoing embodiments according to the technical essence of this application without departing from the content of the technical solutions of this application shall fall within the scope of the technical solutions of this application.

What is claimed is:

1. A liquid crystal display, comprising:
a middle frame;
a backlight unit, comprising a backlight module and a bezel carrying the backlight module; and
a liquid crystal display panel, assembled to the bezel by means of a spacer plate, wherein
a dark or opaque adhesive is formed between the middle frame and the bezel to bond the middle frame and the bezel to each other.

2. The liquid crystal display according to claim 1, wherein the adhesive is a black silica gel.

3. The liquid crystal display according to claim 2, wherein a thickness of the black silica gel is 0.3 mm.

4. The liquid crystal display according to claim 2, wherein the black silica gel is formed between the middle frame and the bezel by using a dispensing process of a dispenser.

5. The liquid crystal display according to claim 2, wherein an optical density value of the black silica gel is in a range of 2/0.8 μm to 2/0.2 μm.

6. The liquid crystal display according to claim 5, wherein an optical density value of the black silica gel is 2/0.5 mm.

7. The liquid crystal display according to claim 1, wherein the backlight module comprises a diffuse sheet, a prism sheet, and a dual brightness enhancement film sequentially superimposed on the bezel.

8. The liquid crystal display according to claim 1, further comprising a joining tape bonding the liquid crystal display panel and the spacer plate.

9. The liquid crystal display according to claim 1, wherein the spacer plate and the middle frame are integrally formed.

10. The liquid crystal display according to claim 9, wherein the spacer plate is formed by extending from the middle frame toward a direction between the bezel and the liquid crystal display panel.

11. A liquid crystal display, comprising:
a middle frame;
a backlight unit, comprising a backlight module and an aluminum bezel carrying the backlight module, wherein the backlight module comprises at least a diffuse sheet, a prism sheet, and a dual brightness enhancement film sequentially superimposed on the aluminum bezel; and
a liquid crystal display panel, assembled to the aluminum bezel by means of a spacer plate, wherein
a dark or opaque adhesive is formed between the middle frame and the aluminum bezel by using a dispensing process of a dispenser, so that the middle frame and the aluminum bezel are bonded to each other;
the spacer plate and the middle frame are integrally formed, and the spacer plate is formed by extending from the middle frame toward a direction between the bezel and the liquid crystal display panel;
the dark adhesive is a black silica gel.

12. The liquid crystal display according to claim 11, wherein an optical density value of the black silica gel is in in a range of 2/0.8 μm to 2/0.2 μm.

13. The liquid crystal display according to claim 12, wherein an optical density value of the black silica gel is 2/0.5 mm.

14. The liquid crystal display according to claim 11, further comprising a joining tape bonding the liquid crystal display panel and the spacer plate.

15. The liquid crystal display according to claim 14, wherein the joining tape is an adhesive such as a double-sided tape, a foam tape, or a light shielding tape.
